(19) United States
(12) Patent Application Publication
(10) Pub. No.: US 2026/0364846 A1
(43) Pub. Date: Nov. 19, 2026

(54) METHODS FOR THE MANUFACTURING OF COMPOSITE BOARDS FROM TEXTILE AND WOOD FIBERS

(71) Applicant: Maplex Technology Ltd, Cambridge (GB)

(72) Inventor: Simon Kew, Cambridge (GB)

(21) Appl. No.: 19/470,791

(22) PCT Filed: Mar. 6, 2024
(86) PCT No.: PCT/IB2024/052164

§ 371 Date: Sep. 29, 2025

(30) Foreign Application Priority Data
Mar. 28, 2023 (GB) 2304498.5

(51) Int. Cl. B27N 3/04; B27N 3/18

(52) U.S. Cl. CPC B27N 3/04; B27N 3/18

(57) ABSTRACT

An aspect of the present invention provides a method for the manufacturing of a composite board from textile and wood fibers, the method comprising: shredding and/or milling textile waste to create a fibrous composite fluff; application of coatings and/or adhesives to the fibrous composite fluff using a blow-line; use of process data to control at least one process parameter in the blow-line; combination and mixing of the fibrous composite fluff with wood-based fibers to produce a uniform blend of fibrous composite fluff and wood-based fibers; and pressing and forming of the uniform blend of fibrous composite fluff and wood-based fibers to produce a composite fiber board.

### FIELD

The present invention relates to methods for the manufacturing of composite boards from textile and wood fibers. Composite boards manufactured according to methods of the present invention may be used for many applications including in connection with furniture and construction.

### BACKGROUND

The fashion and textile industry is a significant contributor to pre- and post-consumer waste, generating over 50 million tons of waste in 2022, most of which ends up in landfills or is incinerated. Recycling textiles is difficult due to the heterogeneous nature of textile products, which include zippers, buttons, and labels, and are usually composed of blended fabrics such as polyester and cotton. Furthermore, waste textiles can be obtained from a diverse range of sources, including post-consumer waste (such as clothing and footwear), pre-consumer waste (such as cutting waste from garment manufacturing), construction waste, geotextiles, agricultural membranes, and landfill waste. Textile fibers consist primarily of polyester, cotton, man-made cellulose, nylon, and wool, each of which possess unique mechanical properties and surface chemistry. In addition, most textile fibers have been treated with dyes or pigments and coated with functional chemistry, such as waterproofing agents.

The current textile-to-textile recycling rate is less than 1%, primarily due to the challenges associated with collecting, sorting, disassembly, and chemically degrading textile products into raw materials. While there are ongoing efforts to develop textile-to-textile recycling processes, these processes are likely to remain a small-scale niche due to the energy-intensive and green house gas (GHG) emitting nature of the processes. Moreover, using virgin materials such as petrochemical-derived polyester or cultivated cotton may result in fewer GHG emissions compared to textile-to-textile recycling. Therefore, there is a pressing need to explore alternative strategies to recycle end-of-life textiles to avoid landfill and incineration, which contribute to environmental pollution. The current state of textile waste management necessitates the development of new technologies that can address the challenges of textile waste, promote sustainability, and reduce GHG emissions.

To address the challenges of textile waste, there is a need to find alternative strategies to recycle end-of-life textiles to avoid landfill and incineration. One promising solution is to use textile waste as a raw material for structural board, as textile products inherently embody mechanical strength. However, to date, attempts to use textile waste to form construction boards have been limited due to the absence of a large-scale continuous production method that meets standardized specifications.

Although the use of textile fiber waste for board production has been limited so far due to the lack of a large-scale continuous production method capable of producing standardized boards (ISO 16895:2016) and the inability to utilize unprocessed textile waste, the construction and furniture industries heavily rely on consistent, large-scale board materials that meet standard technical performance specifications. As such, it is crucial to enable the large-scale recycling of textile waste into boards that meet these specifications, delivering a sustainable solution to the problem of textile waste management. Notably, there have been some attempts to use textile waste for MDF board production, but these methods have thus far been unable to meet the required standards of the construction and furniture industries and are only at laboratory scale.

Medium density fibre (MDF) board is a widely used construction material manufactured from wood that has been shredded and milled into a fibrous fluff, typically featuring dimensions ranging from 10 to 100 millimeters by 10 to 100 microns. Wood chips and sawdust are collected from various sources, including sawmills and furniture factories. These materials are sorted and cleaned to remove any contaminants, such as metal or plastic. The wood fibers are created by grinding the wood chips and sawdust into small particles using a defibrator machine. The resulting fibers are screened to remove any oversized or undersized particles. The wood fibers are then mixed with wax and resin binder in a blending process or more commonly, these chemistries are applied in a blowline. The exact composition of the binder and the amount of wax used depend on the desired properties of the final product. The blended mixture is formed into a mat by spreading the fibers out evenly on a conveyor belt. The mat is then pre-compressed to remove any excess air and improve the overall density of the board. The pre-compressed mat is then placed in a hot press, where it is subjected to high pressure and temperature. This causes the resin binder to melt and bond the wood fibers together. After the hot press, the MDF board is cooled and trimmed to the desired size and shape. It is then sanded to a smooth finish, and any excess dust or debris is removed.

Depending on the final application, the MDF board may be laminated with a decorative veneer or coated with a layer of paint or primer. Industrial plants that produce MDF boards are capable of outputting between 200,000 and 500,000 tonnes of board each year, making MDF boards a popular and valuable construction material due to their durability and versatility. An example process of manufacturing MDF boards is shown in FIG. 1.

The present invention has arisen in light of the aforementioned background.

### SUMMARY

An aspect of the invention provides a novel process for recycling various textile products, including clothing, shoes, and upholstery fabrics. The process involves shredding and milling these products into a homogeneous fibrous composite fluff that can be used as a raw material in an industrial medium density fibre (MDF) board production process. A unique feature of the invention is the use of a blow-line to coat the textile fibers, allowing for the production of composite textile-wood boards in a continuous process. The range of inputs for the textile products is broad, including polyester, cotton, nylon, man-made cellulose, and blends of these fabrics. In addition, the process can recycle whole garments and other fabric-containing items, without requiring preparatory steps. The composite boards produced through this process exhibit properties that are superior to those of conventional 100% wood composition fiber boards, providing a sustainable and eco-friendly alternative to existing products.

Textile products possess a fibrous nature that inherently imbues them with significant mechanical strength, making them an excellent raw material for structural board production. Directly processing textile items to create raw material for construction board, presents a highly promising and practical large-scale approach to recycling textiles in an environmentally responsible manner. By leveraging the inherent mechanical strength of textiles, this innovative process offers a sustainable and scalable alternative to conventional board production methods, contributing to a more sustainable future.

An aspect of the invention provides a method for the manufacturing of composite boards from textile and wood fibers, the method comprising: shredding and/or milling textile waste to create a fibrous composite fluff; application of coatings and/or adhesives to the fibrous composite fluff using a blow-line; use of process data to control at least one process parameter in the blow-line; combination and mixing of the fibrous composite fluff with wood-based fibers to produce a uniform blend of fibrous composite fluff and wood-based fibers; and pressing and forming of the uniform blend of fibrous composite fluff and wood-based fibers to produce a composite fiber board.

Composite boards manufactured using the above method are substantially comparable in properties to conventional wood-based medium density fibre board and can be manufactured using the same large-scale continuous manufacturing process lines installed worldwide. Typical MDF boards are commodity materials commanding pricing that reflects their comparability to timber. Additionally, such composite boards can be designed to achieve high-value properties by selecting textile fibers with specific properties.

Composite boards manufactured using the above method, which are a combination of wood and textile fibers, adhered using a resin into a board structure with density 0.5-1.2 g/cm3, can be recycled in a secondary recycling step to fibrous raw materials suitable for recycling as board. The recycling route may include the disassembly of the board-containing product followed by a hammer milling process to generate a fibrous composite fluff. The resulting fibrous composite fluff may again be used to manufacture new composite boards using the above method.

In one embodiment, the fibrous composite fluff has dimensions of 10-100 mm×10-100 microns.

In one embodiment, the uniform blend of fibrous composite fluff and wood-based fibers comprises at least 50% by mass of fibrous composite fluff and 50% or less by mass of wood-based fibers.

In one embodiment, the application of coatings and adhesives to the fibrous composite fluff in the blow-line comprises sequential introduction of chemicals of differing chemical compositions that are determined based on one or more properties of the fibrous composite fluff within the blow-line.

In one embodiment, the one or more properties of the fibrous composite fluff within the blow-line are determined using near infra-red spectroscopy.

In one embodiment, the one or more properties of the fibrous composite fluff within the blow-line comprise: composition, water content, dimensions, and density of the fibrous composite fluff.

In one embodiment, the fibrous composite fluff and wood-based fibers are mixed together prior to introduction to the blow-line.

In one embodiment, the fibrous composite fluff and wood-based fibers are processed separately in respective blow-lines and mixed together after application of coatings and adhesives to the fibrous composite fluff and wood-based fibers.

In one embodiment, the one or more properties of the fibrous composite fluff within the blow-line is used to set process parameters including the composition ratio of fibrous composite fluff and wood-based fibers and to determine pressing parameters including time, temperature, and pressure.

In one embodiment, introduction of fibrous composite fluff into the blow-line is at a continuous flow rate and the flow rate may be varied based on the determined one or more parameters of the fibrous composite fluff within the blow-line.

In one embodiment, the composite board is continually pressed at a temperature between 150 C and 220 C and at a pressure of 20-200 tonnes/m2 for 1-15 minutes.

In one embodiment, the method further comprises the step of removing ferrous particles from the fibrous composite fluff through use of a magnet.

In one embodiment, the method further comprises the step of sifting the fibrous composite fluff to remove large particles.

In one embodiment, the method further comprises the step of selection of particle sizes.

In one embodiment, the coatings and adhesives are selected from: soluble nanocellulose, suspended cellulosic fibers, starch, polyvinylacohol, polyvinylpyrollidone, chitosan, gelatine, hydrowax, syntec blue, paraffin wax, shellac, carnauba wax, microcrystalline wax, formaldehyde-urea, formaldehyde-phenol, melamine-formaldehyde-urea, polymeric methylene di-isocyanate, polyurethane resin, acrylate, albumin, chitosan, exopolysaccharide (from bacteria), gum Arabic, carbodiimide crosslinkers, epichlorohydrin crosslinkers, epoxides, dialdehydes, and quinones.

In one embodiment, the colour of the resulting composite board is controlled from selecting fibrous composite fluff have desired colour characteristics.

In one embodiment, the water resistance of the composite board is controlled by selecting fibrous composite fluff that has hydrophobic properties.

In one embodiment, the mechanical strength of the composite board is controlled by selecting fibrous composite fluff that comprises a significant mass of high strength textile fibre.

Another aspect of the invention comprises a composite board manufactured from a uniform blend of fibrous composite fluff derived from waste textiles and wood-based fibers.

In one embodiment, the composite board has a density 0.5-1.2 g/cm3.

In one embodiment, the composite board comprises a sandwich construction having at least three layers, a first outer layer comprising 100% wood fibers, a second outer layer comprising 100% wood fibers, and an intermediate layer comprising at least 50% by mass.

### BRIEF DESCRIPTION OF THE FIGURES

The figures provided in this specification serve to further illustrate and explain the various aspects and embodiments of the present invention. In particular, the following figures depict several embodiments of the disclosed method. It is understood that the specific configurations and details shown in the figures are not intended to be limiting, and that other variations and modifications of the invention are possible.

FIG. 1 is a flow chart of a prior art method of manufacturing MDF boards.

FIG. 2a is a simplified flow chart of a prior art method of manufacturing MDF boards.

FIG. 2b is a modified version of the flow chart of FIG. 2a incorporating the introduction of textile fibers.

FIG. 3 illustrates operation of a blow-line according to the disclosure.

### DETAILED DESCRIPTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

A key aspect of the present invention is the ability to convert unprocessed, unsorted textile waste streams into a fibrous textile fluff that can be combined with wood fibers to produce a technically capable construction board. To create a fibrous composite fluff from textiles, the textile waste is typically shredded and milled. The shredding process involves cutting the textiles into small pieces or strips, while the milling process grinds the textiles into smaller particles. The combination of these processes results in a fibrous composite fluff material made up of small fibers with typical dimensions ranging from 10 to 500 millimeters by 10 to 100 microns. The shredding process may also remove metallic contamination via magnets and also sift out any large particulate debris from the flow of fibrous composite fluff. The resulting stream of fibrous composite fluff material is suitable for use as a raw material in the production of composite boards.

The present invention relies on two main attributes: first, the production of a fibrous material with appropriate physical characteristics, and second, the production of fiber surfaces with appropriate chemical characteristics. The textile material is typically collected in bundles of over 100 kg from a wide range of sources, with post-consumer garments and pre-consumer cutting room waste from garment manufacturing being the most preferred sources. The majority of textile waste originates from pre-consumer cutting room waste, with up to 20% of fabric production being sent to waste during this process. The collected textile items can be either flat fabrics or structured garments, and are shredded using a knife-based comminution process at a rate of 1 to 10 tonnes per hour per machine. This process ensures that the shredded fabric material includes embellishments such as buttons and zippers.

Wood based materials may also be utilised as an input and converted to wood fibers using a traditional fibre-board manufacturing process. The wood inputs include logs, wood waste, recycled wood furniture, medium density fibre board. The inputs to the wood process can also include cellulosic crops such as bamboo, hemp and bagasse.

The characteristics of the finished board can be precisely tailored by carefully choosing the raw material inputs. By utilizing categorized textile waste, it is possible to regulate board attributes such as color, mechanical strength, flame retardancy, and more. Research has demonstrated that a variety of advantageous properties can be attained by methodically pre-sorting waste sources based on composition, color, and fiber size. For instance, the optimization of input materials has led to enhancements in the following properties: (i) enhanced water resistance through the incorporation of hydrophobic polyester fibers; (ii) increased mechanical strength by integrating nylon fibers; (iii) preservation of the wood-like color aesthetic with the use of white cotton fibers; and (iv) augmented impact resistance by incorporating Kevlar® and other aramid fibers.

A significant aspect of the presentation invention lies in its ability to consistently supply textile fibers to a fiberboard production process. As the operation progresses, the composition and quantity of textile fibers may fluctuate. To ensure uninterrupted operation, it is essential to monitor the composition, fiber dimensions, and water content in-line, which in turn can be used to regulate the downstream chemistry additions in the blow-line and the upstream fiber comminution processes.

For instance, it is possible to assess fiber composition utilizing near-infrared spectroscopy, determine fiber physical parameters through dynamic light scattering and/or optical imaging, and gauge water content with near-infrared spectroscopy. A pivotal element of this process design is the capacity to connect online measurements with the process parameters employed for introducing textile waste. Process parameters that can be adjusted in a closed-loop online process based on the obtained parameters include mass flow, chemistry additions, pressing pressures, and temperatures.

Central to this invention is the ability to process textile fibers in-line at high throughput using a blow-line, achieving a throughput comparable to that of a traditional wood fiber board production process. A blow-line is a critical part of the MDF manufacturing process that conventionally involves applying the resin chemistry to the wood fibers in-line at high throughput. The blow-line is located just before the primary tube dryer and consists of a series of high-pressure air jets that deliver liquids to the wood fibres.

In the present invention, textile fluff is also coated with chemistry using a blow-line. Fibers are transported at supersonic speeds while being sequentially coated with liquid chemistry from an array of spray nozzles. This sequential chemistry addition is employed to control surface chemistry and fiber-fiber adhesion, enabling the use of a diverse array of textile fibers with varying properties.

Ideally, data generated from online monitoring is used to set the chemistry coating parameters applied in the blow-line.

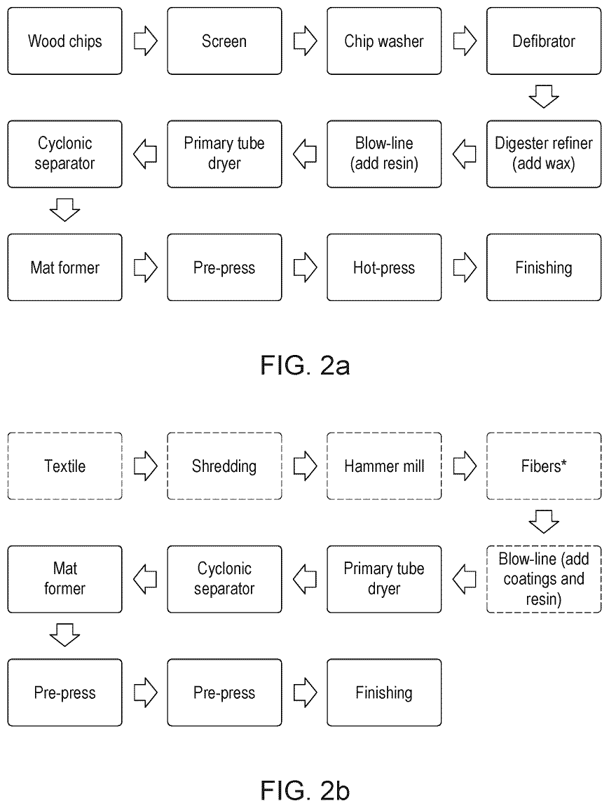

Textile fibers can also be introduced into the process prior to the wood-fiber coating process and processed with wood fibers in the wood-fiber blow-line. It may be necessary to implement a mixing system before the blow-line to enable homogeneous mixing. This is illustrated by the flow chart at FIG. 2b.

Alternatively, textile fibers may be introduced into the primary tube dryer, located immediately after the wood-fiber blow-line, where it mixes with wood fibers and undergoes evaporation-driven drying before entering the cyclone separator. The textile waste and wood fibers are mixed in proportions determined by a mass-flow control system. Within the cyclone, small particulate debris is expected to be removed from the fiber mass, while the cyclonic motion further mixes the wood and textile fibers.

During fiberboard production, the availability of textile fibers may vary, necessitating adjustments to the textile fiber throughput. In such cases, it may be required to increase or decrease the wood fiber flow rate to ensure continuous operation. The composition of textile waste and wood fibers may range from 5-95% textile fibers.

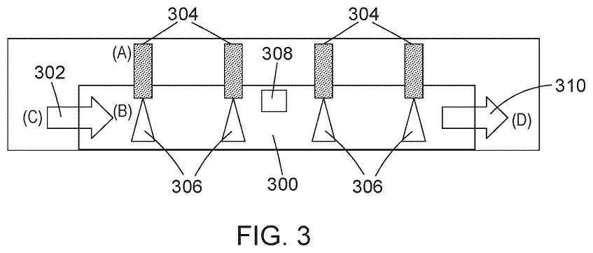

As shown in FIG. 3, a blow-line 300 comprises at least one chemistry delivery input 302 for delivering chemistry components to the blow-line and at least one fibre input 304 for delivering textile fibers to the blow-line. The fibre input 304 may be arrange perpendicular to the chemistry input 302 to permit cross flows of fibre and chemistry components. The chemistry input 302 comprises a spray module 306 to provide a wide angled spray of the chemistry components into the blow-line 300. A near infra-red spectroscopy sensor 308 is provided within the blow tube 300 to enable the composition of fibers to be monitored in-line in the blow tube 300. The chemistry components may be varied to take into account variances in the characteristics of the fibers as determined by the near infra-red spectroscopy sensor 308. As shown, several chemistry inputs 302 may be provided, each associated with a respective spray module. Depending on the determined characteristics of the textile fibers, the volume, composition, chemistry component type, for example, may be varied in response to changes in the determined characteristics of the textile fibers.

The waste textile fibers are optimally coated with a chemistry specifically chosen based on their composition. These resin-coated textile fibers are then preferably dried and combined with wood fibers in the dryer before being separated in the cyclone. The fiber mixture undergoes refinement in the cyclone, which eliminates fines and conveys the mixture to the first fiber conveyor, where a mat is formed.

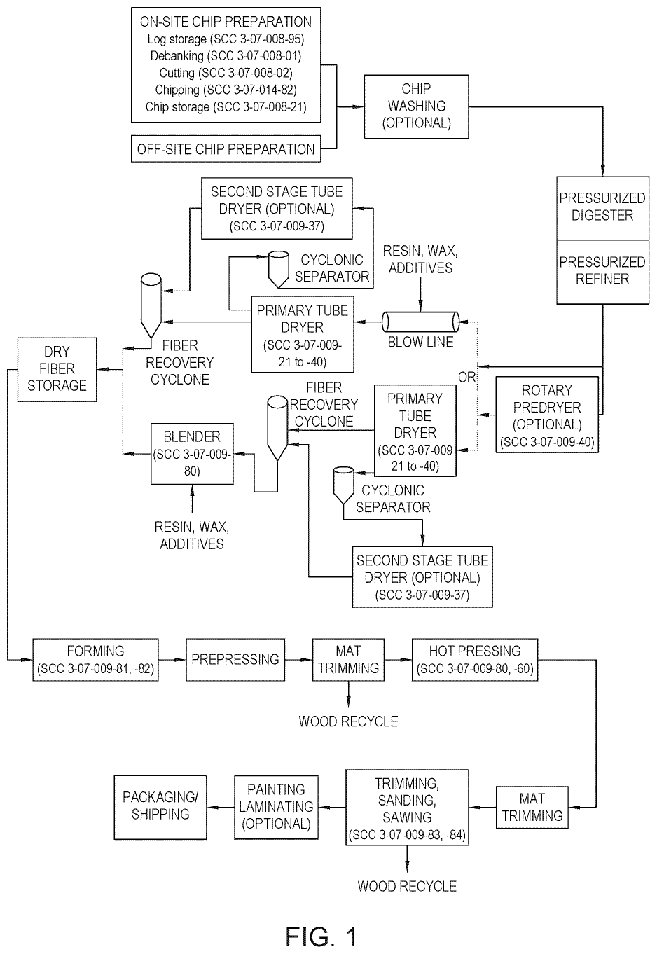

From this point onward, fiberboard production follows the same process as that of a 100% wood-based board, as illustrated in FIGS. 1 and 2. This process feature allows for the integration of varying quantities and compositions of textile fibers in a continuously operating system, without additional changeovers and downtime compared to a 100% wood fiber process.

The fiberboards undergo compression in two stages, with a combination of heat and pressure curing the adhesive and resins, resulting in a mechanically robust board. Following pressing, the board is cooled, sanded, sized, cut, and graded before packaging.

The textile/wood composite boards exhibit qualities closely resembling those of wood-based boards, allowing for comparable downstream processing. Typical operations encompass: sanding, cutting, painting, and coating. These textile-wood composite fiberboards find applications in diverse sectors, such as architecture, furniture, flooring, retail displays, and various home improvement construction projects.

Table 1 (see below) provides a comparison of the properties of conventional MDF boards against composite textile-wood fibre boards described herein.

TABLE 1
comparison of the properties of MDF particle board against boards
manufactured in accordance with the present disclosure.

| | | | | | | | Bending | Modulus |
|---|---|---|---|---|---|---|---|---|
| | | | | Swelling | | Internal | strength | of elasticity |
| | | | | (EN 337 | | bond (IB) | (MOR) | (MOE) |
| | Material | Thick- | Density | 24 hr) | | (EN 319) | (EN310 | (EN 310) |
| Board | composition | ness/mm | [kg/m3] | [%] | | [MPa] | [MPa] | [MPa] |
| Particle | 83-88% | 9 | 600-680 | 17% | | 0.4 | 11 | 1800 |
| board (EN | wood, 6% | | | | | | | |
| 312-2) | binder, 1% | | | | | | | |
| | wax; 5% water | | | | | | | |
| MDF Dry | 90% wood | 9 | 550-800 | 15% | (15%) | 0.6 (0.65) | 22 (27) | 2500 (2800) |
| Use (LA) | fibers, 8% | | | | | | | |
| (EN 622-5: 2009) | resin, 2% wax | | | | | | | |
| MDF.H | 90% wood | 9 | 550-800 | 10% | (10) | 0.8 (0.8) | 26 (32) | 2500 (2800) |

| | | | | | | | |
|---|---|---|---|---|---|---|---|
| (HLS) Wet Use | fibers, 8% | | | | | | |
| (EN 622-5: 2009) | resin, 2% wax | | | | | | |
| Light L-MDF | 90% wood | 9 | 550-800 | 16% | 0.45 | 20 | 1700 |
| | fibers, 8% | | | | | | |
| | resin, 2% wax | | | | | | |
| Ultra-light | 90% wood | 9 | 550-800 | 18% | 0.35 | 18 | 1400 |
| UL1-MDF | fibers, 8% | | | | | | |
| | resin, 2% wax | | | | | | |
| Wood/ | 60% Textile | 9 | ~600 | <15% | >0.5 | >20 | >1500 |
| Textile | waste, 25% | | | | | | |
| Composite | wood fibers, | | | | | | |
| Board | 10% resin, | | | | | | |
| | 2% wax | | | | | | |

ThS—thickness swelling
MOR—Modulus of rupture
MOE—Modulus of elasticity
IB—Internal bond

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

1. A method for the manufacturing of composite boards from textile and wood fibers, the method comprising:
shredding and/or milling textile waste to create a fibrous composite fluff; application of coatings and/or adhesives to the fibrous composite fluff using a blow-line;
use of process data to control at least one process parameter in the blow-line;
combination and mixing of the fibrous composite fluff with wood-based fibres to produce a uniform blend of fibrous composite fluff and wood-based fibers; and
pressing and forming of the uniform blend of fibrous composite fluff and wood-based fibers to produce a composite fiber board.

2. The method of claim 1, wherein the fibrous composite fluff has dimensions of 10-100 mm×10-100 microns.

3. The method of claim 1, wherein the uniform blend of fibrous composite fluff and wood-based fibers comprises at least 50% by mass of fibrous composite fluff and 50% or less by mass of wood-based fibers.

4. The method of claim 1, wherein the application of coatings and adhesives to the fibrous composite fluff in the blow-line comprises sequential introduction of chemicals of differing chemical compositions that are determined based on one or more properties of the fibrous composite fluff within the blow-line.

5. The method of claim 3, wherein the one or more properties of the fibrous composite fluff within the blow-line are determined using near infra-red spectroscopy.

6. The method of claim 4, wherein the one or more properties of the fibrous composite fluff within the blow-line comprise: composition, water content, dimensions, and density of the fibrous composite fluff.

7. The method of claim 1, wherein the fibrous composite fluff and wood-based fibers are mixed together prior to introduction to the blow-line.

8. The method of claim 1, wherein the fibrous composite fluff and wood-based fibers are processed separately in respective blow-lines and mixed after application of coatings and adhesives to the fibrous composite fluff and wood-based fibers.

9. The method of claim 3, wherein the one or more properties of the fibrous composite fluff within the blow-line is used to set process parameters including the composition ratio of fibrous composite fluff and wood-based fibers and to determine pressing parameters including time, temperature, and pressure.

10. The method of claim 8, wherein introduction of fibrous composite fluff into the blow-line is at a continuous flow rate and the flow rate may be varied based on the determined one or more parameters of the fibrous composite fluff within the blow-line.

11. The method of claim 1, wherein the composite board is continually pressed at a temperature between 150 C and 220 C and at a pressure of 20-200 tonnes/m2 for 1-15 minutes.

12. The method of claim 1, further comprising the step of removing ferrous particles through use of a magnet.

13. The method of claim 1, further comprising the step of sifting the fibrous composite fluff remove large particles.

14. The method of claim 1, further comprising the step of selection of particle sizes.

15. The method of claim 1, wherein the coatings and adhesives are selected from: soluble nanocellulose, suspended cellulosic fibers, starch, polyvinylacohol, polyvinylpyrollidone, chitosan, gelatine, hydrowax, syntec blue, paraffin wax, shellac, carnauba wax, microcrystalline wax, formaldehyde-urea, formaldehyde-phenol, melamine-formaldehyde-urea, polymeric methylene di-isocyanate, polyurethane resin, acrylate, albumin, chitosan, exopolysaccharide (from bacteria), gum Arabic, carbodiimide crosslinkers, epichlorohydrin crosslinkers, epoxides, dialdehydes, and quinones.

16. A composite board manufactured by the method steps of claim 1.

17. The composite board of claim 16 having a density 0.5-1.2 g/cm3.

18. The composite board of claim 16 comprising a sandwich construction having at least three layers, a first outer layer comprising 100% wood fibers, a second outer layer comprising 100% wood fibers, and an intermediate layer comprising at least 50% by mass.

19. The composite board of claim 18 having hydrophilic or hydrophobic properties defined by the hydrophilic or hydrophobic properties of the fibrous composite fluff.
